(19) United States
(12) Patent Application Publication
(10) Pub. No.: US 2006/0202445 A1
(43) Pub. Date: Sep. 14, 2006

(54) Instrument panel provided with a trap held by clamps

(76) Inventors: Séverine épouse Boulbes Mordel, Franconville (FR); Sébastien Laime, Meru (FR)

Correspondence Address: YOUNG & THOMPSON, 745 SOUTH 23RD STREET, 2ND FLOOR, ARLINGTON, VA, 22202, US

(21) Appl. No.: 10/565,169

(22) PCT Filed: Jul. 22, 2004
(86) PCT No.: PCT/FR04/01956

§ 371 Date: Jan. 19, 2006

(30) Foreign Application Priority Data
Jul. 23, 2003 (FR) 03/09008

(51) Int. Cl. B60R 21/215; B60R 21/205

(52) U.S. Cl. 280/728.3; 280/732

(57) ABSTRACT

An instrument panel cover (1) for covering an airbag includes a trap (10) for passing the airbag through the cover, a main part (12) extending around the trap, clamps (14) extending between the trap (10) and the main part (12), discontinuous openings (16) which separate the trap (10) and the main part (12) from each other and are interrupted by the clamps (14), mechanical faults (18) extending between two successive openings (16) not by the elongation thereof but by the retraction of the main part (12) in such a way that while arranging the airbag, a structural layer is broken along the mechanical faults (18), thereby opening the trap (10) and all clamps by displacement thereof with respect to the rest of the structural layer.

The invention relates to a dashboard cover which is to cover an inflatable airbag module.

US-A-2002/0153710 describes a cover composed of several layers including a structural layer of rigid plastics material, a skin and a layer of foam extending between the structural layer and the skin, said structural layer having:
at least one flap which is to allow the inflatable airbag to pass through the cover,
a main portion extending around said flap,
bridges extending between the flap and the main portion, and
discontinuous openings separating said flap and said main portion from each other, said openings being interrupted by said bridges,
mechanically weak regions extending between two consecutive openings.

When it is deployed, the inflatable airbag pushes on the flap. The bridges holding the flap in position relative to the main portion break under the force and the flap opens. However, the breakage of the bridges generates projecting elements of material which could damage the inflatable airbag.

In order to prevent the bridges, by breaking, from constituting a potential source of damage to the inflatable bag, in accordance with the invention, the mechanically weak regions extend not in the extension of said consecutive openings but set back inside the main portion, so that, when the airbag is deployed, the cover breaks along the mechanically weak regions, the bridges as a whole and the flap constituting an assembly which opens by displacement relative to the rest of the cover.

Thus, the breakage surface no longer projects but, on the contrary, is set back relative to the openings provided in the cover, which prevents the inflatable airbag from coming into contact therewith when it is deployed.

Preferably, the mechanically weak regions are constituted by grooves.

That solution is simple to produce, inexpensive and efficient.

In order further to reduce the risk of damaging the inflatable airbag, in accordance with an additional feature, the bridges are mechanically reinforced relative to the main portion of the structural layer.

The breakage of the bridges is thus even less probable, which promotes the breakage of the cover in the main portion, along the grooves.

Preferably, the bridges incorporate a rib extending transversely relative to the longitudinal direction of the openings between which the corresponding bridge extends.

That solution is also simple to produce, inexpensive and efficient.

In accordance with a further advantageous feature of the invention, the main portion, the flap and the bridges define an integral assembly.

The invention will emerge even more clearly from the following description which is given with reference to the appended drawings in which:

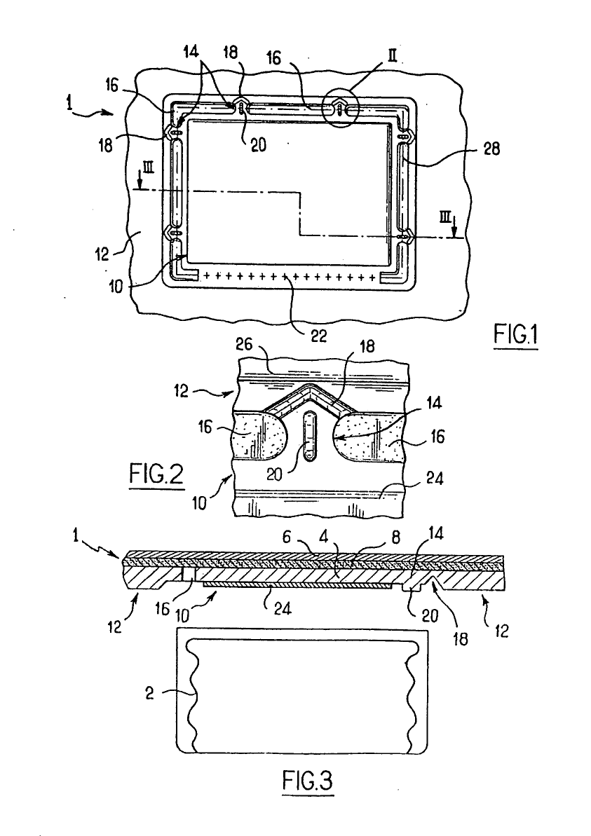

FIG. 1 is a plan view of a cover according to the invention,

FIG. 2 is a view on an enlarged scale of the region marked II in FIG. 1,

FIG. 3 is a sectioned view taken on the line marked III-III in FIG. 1.

The Figures illustrate a cover 1 defining a portion of a dashboard and covering an inflatable airbag module 2, said inflatable airbag being intended for deployment through the cover 1 in the direction towards a motor vehicle passenger.

Said cover 1 comprises a structural layer 4 of rigid plastics material, a layer of foam 8 providing a soft feel, and a covering layer constituted by a skin 6.

In order to facilitate the passage of the inflatable airbag through the cover 1, openings 16 have been provided over the entire thickness of the structural layer 4. Those openings 16 delimit a flap 10 which is to open under the pressure of the inflatable airbag. They are practically free from projecting portions.

The flap 10 is connected to a main portion 12 of the structural layer 4 by a region of material forming a hinge 22 (symbolized by crosses in FIG. 1) and by bridges 14 of material extending between two consecutive openings 16.

As illustrated, the flap 10 is substantially rectangular. It is delimited on three substantially rectilinear sides by the openings 16, which are substantially extensions of each other in a longitudinal direction 28, and on the fourth side by the hinge 22.

The structural layer 4 has a mechanical reinforcement formed by substantially rectilinear ribs 20 extending transversely to the longitudinal direction 28.

The structural layer 4 also has mechanically weak regions constituted by grooves 18 extending slightly inside the main portion 12, away from the bridges 14, between two consecutive openings 16. Those grooves 18 extend substantially over half of the thickness of the structural layer 4 following a broken line. Alternatively, they could, in particular, be curved.

In order to prevent tears from being propagated into the main portion 12, the structural layer 4 is mechanically reinforced around the openings 16 and the grooves 18, here by an increase in thickness 26. It could also be reinforced by means of a metal plate or an embedded net.

Likewise, the flap is reinforced by a metal plate 24 secured to the flap.

The structural layer 4 is advantageously produced from polypropylene. Advantageously, the grooves 18 are obtained by moulding and the openings 16 are produced by milling. However, it is also possible to proceed in the opposite manner, or to produce the openings and the ribs in the same manner.

1. Dashboard cover (1) which is to cover an inflatable airbag module (2), said cover being composed of several layers including a structural layer (4) of rigid plastics material, a skin (6) and a layer of foam (8) extending between the structural layer and the skin, said structural layer (4) having:
at least one flap (10) which is to allow the inflatable airbag to pass through the cover,
a main portion (12) extending around said flap, and
bridges (14) extending between the flap (10) and the main portion (12),
discontinuous openings (16) separating said flap (10) and said main portion (12) from each other, said openings being interrupted by said bridges (14),
mechanically weak regions (18) extending between two consecutive openings (16),
characterized in that the mechanically weak regions (18) extend not in the extension of said consecutive openings but set back inside the main portion (12), so that, when the airbag is deployed, the structural layer (4) breaks along the mechanically weak regions (18), the bridges (14) as a whole and the flap (10) constituting an assembly which opens by displacement relative to the rest of the cover.

2. Dashboard cover according to claim 1, characterized in that the mechanically weak regions are constituted by grooves (18).

3. Dashboard cover according to claim 1, characterized in that the bridges (14) are mechanically reinforced (20) relative to the main portion of the structural layer.

4. Dashboard cover according to claim 3, characterized in that the bridges incorporate a rib (20) extending transversely relative to the longitudinal direction of the openings between which the corresponding bridge extends, in order to reinforce the bridges mechanically.

5. Dashboard cover according to claim 1, characterized in that the main portion (12), the flap (10) and the bridges (14) define an integral assembly.

6. Dashboard cover according to claim 3, characterized in that the bridges (14) are mechanically reinforced (20) relative to the main portion of the structural layer.
